(19) United States
(12) Patent Application Publication
(10) Pub. No.: US 2023/0237933 A1
(43) Pub. Date: Jul. 27, 2023

(54) HEALABLE SURGICAL TRAINER

(71) Applicant: Jonathan Scott Barton, Santa Barbara, CA (US)

(72) Inventor: Jonathan Scott Barton, Santa Barbara, CA (US)

(21) Appl. No.: 18/101,366

(22) Filed: Jan. 25, 2023

Related U.S. Application Data
(60) Provisional application No. 63/267,117, filed on Jan. 25, 2022.

(51) Int. Cl. G09B 23/30

(52) U.S. Cl. CPC G09B 23/30

(57) ABSTRACT

A surgical trainer facilitates the training of a medical practitioner in one or more surgical includes one or more layers of healable synthetic tissues. The healable synthetic tissue includes healable material configured to facilitate a re-bonding of the healable synthetic tissues to their original shape after an incision is made to the healable synthetic tissues.

### CROSS-REFERENCE TO RELATED PATENT APPLICATION

This application claims priority to and the benefit of U.S. Provisional Patent Application No. 63/267,117, filed on Jan. 25, 2022, the contents of which are hereby incorporated by reference herein for all purposes.

### FEDERALLY SPONSORED RESEARCH AND DEVELOPMENT

The present disclosure was made with government support under (W81XWH20C0063) awarded by the Congressionally Directed Medical Research Program (CDMRP). The government has certain rights in the invention.

### TECHNICAL FIELD

The present disclosure relates, generally, to a surgical trainer. More particularly, the present disclosure pertains to a healable surgical trainer having healable synthetic tissues.

### BACKGROUND

High-quality training of residents is necessary to improve surgeon skills and improve surgery outcomes. Surgery training requires residents to obtain a high skill in performing procedures involving punctures, cuts (incision), excision, trocar insertion, and closure of fascial defects to demonstrate the simulation of laparoscopy and wound closure. Also, better training and practice of medical surgical procedures are expected to improve surgical outcomes, reduce operating times and improve safety. Due to the high expenses, difficulty in obtaining cadavers, and changes in material properties over time, there is a need for synthetic tissues for training purposes. Synthetic tissue for surgery training is generally single-use due to its inability to heal after a procedure. For instance, silicone or polyurethane may be used to simulate tissue. This approach becomes expensive due to low reusability and is environmentally unfriendly.

### SUMMARY

One aspect of this disclosure relates to a surgical trainer to facilitate the training of a medical practitioner in one or more surgical procedures is disclosed. The surgical trainer includes one or more layers of healable synthetic tissues. The healable synthetic tissue includes healable material configured to facilitate a re-bonding of the healable synthetic tissues to its original shape after the incision is made to the healable synthetic tissues.

In some additional, alternative, or selectively cumulative embodiments, the healable synthetic tissues are self-healable synthetic tissues comprising at least one selected from hydrogen bonding, ionic bonding, van der Waal forces, covalent bonding, dynamic hydrogen bonding, hydrophobic interactions, dynamic covalent bonds or Schiff base, disulfide bonds, and Diels-Alder reactions, or a combination of intermolecular interactions.

In some additional, alternative, or selectively cumulative embodiments, the healable synthetic tissues comprise at least a supermolecular, reversible covalent bond, or a combination thereof.

In some additional, alternative, or selectively cumulative embodiments, the healing of the healable synthetic tissue is activated or enhanced by exposing said healable synthetic tissue to at least one factor selected from heat, pH changes, pressure, energy, hydration, water diffusion or a combination thereof. The surface treatment by the addition of at least one healing factor results in the improved strength of the healable synthetic tissue.

In some additional, alternative, or selectively cumulative embodiments, the surgical trainer further comprises one or more layers of non-healable synthetic tissues.

In some additional, alternative, or selectively cumulative embodiments, the healable synthetic tissues comprise one or more self-healing additives to initiate the re-bonding of synthetic tissue material.

In some embodiments, the self-healing additives initiate rebonding of synthetic tissue material via at least one selected from dynamic hydrogen bonding, ionic bonding, van der waal forces, hydrophobic interactions, dynamic covalent bonds or bidirectional reactions such as Schiff base, disulfide bonds, and Diels-Alder reactions, or a combination of intermolecular interactions.

In some additional, alternative, or selectively cumulative embodiments, the surgical trainer comprises a plurality of sensors positioned within at least one layer of the healable synthetic tissues configured to detect both the magnitude and relative position of an external force and incision force or pressure applied to the healable synthetic tissue.

In some additional, alternative, or selectively cumulative embodiments, the sensors are at least one selected from a pressure sensor, a force sensor, a cut sensor, or a combination thereof.

In some additional, alternative, or selectively cumulative embodiments, the healable synthetic tissue further comprises at least one selected from a colorant, a gelling agent, a plasticizer, a humectant, a preservative, or a combination thereof.

In some additional, alternative, or selectively cumulative embodiments, the healable synthetic tissue has a tensile strength in the range of 1 kPa to 100 MPa and compressive strength in the range of 1 kPa to 100 Mpa.

In accordance with another example embodiment, a modular manikin for surgical training simulation is disclosed. The modular manikin includes at least one synthetic body part comprising one or more layers of healable synthetic tissues. The healable synthetic tissues include healable material configured to facilitate a re-bonding of the healable synthetic tissues to its original shape after the incision is made to the healable synthetic tissues.

In some additional, alternative, or selectively cumulative embodiments, the healable synthetic tissues are self-healable synthetic tissues comprising at least one selected from hydrogen bonding, ionic bonding, van der Waal forces, covalent bonding, dynamic hydrogen bonding, hydrophobic interactions, dynamic covalent bonds or Schiff base, disulfide bonds, and Diels-Alder reactions, or a combination of intermolecular interactions.

In some additional, alternative, or selectively cumulative embodiments, the healable synthetic tissues comprise at least a supermolecular, a reversible covalent bond, or a combination thereof.

In some additional, alternative, or selectively cumulative embodiments, the healing of the healable synthetic tissue is activated by exposing said healable synthetic tissue to at least one factor selected from heat, pH changes, pressure, energy, hydration, dehydration, water diffusion, surface modification treatment or a combination thereof.

In some additional, alternative, or selectively cumulative embodiments, at least one synthetic body part comprises one or more layers of non-healable synthetic tissues.

In some additional, alternative, or selectively cumulative embodiments, the healable synthetic tissues comprise one or more self-healing additives to initiate the re-bonding of synthetic tissue material.

Typically, the self-healing additives are selected from at least one but not limited to ionic liquids, Cellulose derivatives such as Carboxyl Cellulose nanocrystals (C—CNCs) Gelatin, Chitosan, Poly vinyl alcohol (PVA), polyols (Sorbitol, Glycerol, etc.), Guar Gum, Carrageenans, Carbon nanotubes, supramolecular structures, and double or triple networks.

In some additional, alternative, or selectively cumulative embodiments, the modular manikin further comprises a plurality of sensors positioned within at least one layer of the healable synthetic tissues configured to detect both the magnitude and relative position of an external force and incision applied to the healable synthetic tissue.

In some additional, alternative, or selectively cumulative embodiments, the sensors are at least one selected from a pressure sensor, a force sensor, a cut sensor, or a combination thereof.

In some additional, alternative, or selectively cumulative embodiments, the healable synthetic tissue further comprises at least one selected from a colorant, a gelling agent, a plasticizer, a humectant, a preservative, or a combination thereof.

In some additional, alternative, or selectively cumulative embodiments, the healable synthetic tissue has a tensile strength in the range of 1 kPa to 100 MPa.

Additional aspects and advantages will be apparent from the following detailed description of example embodiments, which proceeds with reference to the accompanying drawings.

### BRIEF DESCRIPTION OF THE DRAWINGS

FIG. 1 illustrates a surgical trainer, in accordance with an embodiment of the disclosure;

FIG. 2 illustrates a surgical trainer, in accordance with an embodiment of the disclosure;

FIG. 3 illustrates an exploded view of a surgical trainer, in accordance with an embodiment of the disclosure;

FIG. 4 illustrates a modular manikin, in accordance with an embodiment of the disclosure; and

FIG. 5 illustrates a head of the modular manikin, in accordance with an embodiment of the disclosure.

### DETAILED DESCRIPTION

One of the aspects of the present disclosure relates to a surgical trainer, for example, a modular manikin or a portion of a manikin or a synthetic body part or a synthetic organ, suitable to facilitate a training of a medical practitioner in a surgical procedure. According to the aspects of the disclosure, the surgical trainer includes one or more layers of synthetic tissues. According to aspects of the disclosure, the synthetic tissues may include healable synthetic tissues as well as non-healable synthetic tissues. In some embodiments, all the synthetic tissues may include only healable synthetic tissues. The healable synthetic tissues include healable materials to facilitate the re-boding of the synthetic tissues to their original shape after the incision is made to the synthetic tissue. This healing of the healable synthetic tissues enables the surgical trainer to be used multiple times, reducing the overall cost of the training of the surgical procedures.

The healable synthetic tissues are positioned in regions in which surgical procedures are performed to be able to repeat the procedure multiple times and reuse the surgical trainer lowering the overall cost of training. However, regions that will not be cut do not need to be healable so the overall model can be a blend of both healable and not healable materials. It may be appreciated that the healed surface is smoothed to remove the ability for the user to see previous incisions. After the procedure is completed, the synthetic healable tissues return to their initial location and heal back together. The surface can be further smoothed to ensure that the next trainee cannot see the incision location.

Synthetic tissues are biomimetic tissue analogs with realistic properties that are incorporated to teach cutting, suturing, injection, tissue manipulation, or trocar insertion procedures. Synthetic tissues corresponding to different layers or different anatomical structures exhibit properties that match that of physiological tissues (such as strength, moduli, hardness, color, conductivity, hydration, printability, etc.). The mechanical properties of synthetic tissues range significantly, for instance, tensile strength may be in the kPa to 100's of MPa, and elastic constants can be as high as GPa ranges. Preferably, synthetic tissues are biomimetic and nontoxic using some similar materials to that of physiological tissue with analogs that are biocompatible and biodegradable.

In some embodiments, the synthetic tissues utilize similar materials to that of physiological tissue with a gelling agent, plasticizer, humectant, colorant, and preservative. The tissue simulants can be deposited either as molded, subtractively defined computer numerical control (CNC) fabricated parts, or additively manufactured (AM) parts either as separate materials fused, with over-molding of other tissues. The deposition can be through either a combination of extrusion or other non-contact deposition methods. In some embodiments, the layers of synthetic tissues are heterogeneously printed with multiple tissues co-deposited using Additive Manufacturing. In another embodiment, layers of synthetic tissues are over-molded with outside tissue layers to give a very high-fidelity surface finish. The materials can be printed using a thermoplastic blend where they cool down and solidify or using some other sort of crosslinking such as metal ions (ie. Ca+ with Alginate, Gellan Gum, Carrageenan, Aluminum with Gelatin), or light-based crosslinking (ie. UV, visual or other wavelengths). Additionally, multiple solidification methods may be used simultaneously to fix the material using thermoplastic cooling and crosslinking to make the material unable to melt again—for instance, to improve the melting temperature such that the model is robust even in a hot environment.

In some embodiments, synthetic tissues may include colorants to provide improved realism. In an embodiment, inkjet printing of colorant enables higher realism and can be implemented either on the surface and/or embedded tissues either of the surface or layer-by-layer embedded in the tissue.

In some embodiments, the layers of synthetic tissues have desirable printability characteristics within the desired rheology (viscosity, surface energy, etc.) to enable the printing of the material using an additive deposition approach. For instance, this can be achieved using a heated extruder, auger, or pneumatic deposition tool which is either contact or non-contact deposition.

In another embodiment, different materials are either additively printed in different regions to achieve differing or a gradient of mechanical properties. This can be achieved with multiple reservoirs of different materials using the same tool or multiple tools with multiple reservoirs.

The surgical trainer may include multiple anatomical structures having varying thicknesses, color, mechanical properties, or landmark locations with different common and uncommon anatomy variants to simulate variations corresponding to the biological anatomical structures. In some optional embodiments, the layer or synthetic tissues may differ based on location, age, body mass index (BMI), and other factors.

In some embodiments, the healable synthetic tissues contain/include one or more self-healing additives in sufficient concentration such that healing efficiency enables the material to be re-bonded after cutting autonomously. This process additionally allows for multiple cuts and bonding cycles to occur to improve the reusability of the material. The self-healing synthetic tissue composition/materials provides one or more hydrogen bonding, ionic bonding, van der wall forces, covalent bonding, and other molecular bonding forces to drive a self-healing mechanism. More particularly, the self-healing additives initiate the rebonding of synthetic tissue material through at least one but not limited to hydrogen bonding, ionic bonding, van der Waal forces, covalent bonding, dynamic hydrogen bonding, hydrophobic interactions, dynamic covalent bonds or Schiff base, disulfide bonds, host-guest interactions, and Diels-Alder reactions, or a combination of intermolecular interactions.

Typically, the self-healing additives are selected from at least one but not limited to ionic liquids, Cellulose derivatives such as Carboxyl Cellulose nanocrystals (C—CNCs) Gelatin, Chitosan, catechols, Poly vinyl alcohol (PVA), polyols (Sorbitol, Glycerol, etc.), Guar Gum, Carrageenans, Carbon nanotubes, supramolecular structures, and double or triple networks.

It may be appreciated that a wide range of methods and mechanisms of self-healing can be employed, for instance, supermolecular, etc. Supramolecular networks often utilize hydrogen bonds. Both the strength of a hydrogen bond and the quantity and distribution of a hydrogen bond is crucial for such a self-healing system. Hydrogen bonds can achieve high strength and relatively fast healing times. Alternatively, microcapsules or microvascular structures, and hydration of freeze-dried self-healing materials can be used. In emulating a wide range of mechanical properties of tissues (i.e., skin, muscle, fascia, adipose, bone, cartilage) self-healing is achieved using single or multiple healing mechanisms.

In some embodiments, the healable synthetic tissues may be healed by applying additional one or more healing parameters/factors such as, but not limited to, heat, pH changes, other energy sources, pressure, hydration, dehydration, and adhesion promoting surface treatment. For example, healable synthetic tissues having composition or materials that include reversible covalent bonds are difficult to heal, however dynamic covalent bonds can be reconfigured by applying energy in the form of heat or light or other stimuli such as pH changes, for healing the synthetic tissues. In some embodiments, materials having ionomer interaction can be employed, which yields significant mechanical strength and stiffness that apply to load-carrying structures.

Typically, the healable synthetic tissues may be healed by applying adhesion promoting surface treatment such as dehydration. In an exemplary embodiment, the healable synthetic tissues are an adhesive which mimics the mammal tissue after suitable dehydration treatment. It may be appreciated that for a given material there is an optimum water content for the best adhesion strength. Polar water molecules can shield functional groups and for high water contents, it will inhibit adhesion junctions. The action of diffusing water through the healing tissue interface provides an additional mechanism for healing the tissue. This can occur due to hydration gradients in the material and control over the external humidity to provide movement of water which also acts to reorganize the bonding interface. As the material reaches a steady state of water content after being either dehydrated or excessively hydrated improves the healing efficiency.

In one embodiment, the healable synthetic tissue is a surface modifying agent which forms a thin layer on the surface. In the preferred embodiment, the surface modifying agent is an adhesive functioning as a filler that adheres to the materials. The adhesive material binds on the surface where the cut is not clean and there can be discontinuities on the synthetic tissue surface.

In some embodiments, healable synthetic tissues may include humectants to retain moisture over time to draw in moisture when the surface is cut to enhance healing efficiency. Humectants are selected so that they increase the amount of time for which the tissue is left exposed and can be bonded back together.

In some embodiments, the surgical trainer may include fluid reservoirs from which liquid is emitted when ruptured. The fluid reservoir may either incorporate dye and/or have pressure to release when accidentally punctured indicating that the surgery had complications.

In some embodiments, the surgical trainer may include a plurality of sensors, for example, pressure sensors and cut sensors embedded in one or more layers of synthetic tissues (healable and non-healable) arranged/disposed of proximate to the region where pressure is applied (landmarks) and/or at the location of incisions. In some embodiments, the sensors include non-intrusive embedded electrical circuits to realize pressure, cut, and other sensor monitoring capabilities. Typical electrical circuits are made with either metal, carbon, or electrically conducting polymers. Highly black or metallic layers of circuits are usually very noticeable to the trainee when placed in the region to be cut. Further sensors are disposed in the layers of synthetic tissues to provide feedback to the trainee about the location and pressure applied (for instance landmark locations) and the location and timing of the cut. Sensors may include nonobtrusive conductors which are a component of both cut sensors and pressure sensors, electrically and ionically insulative material, and piezoresistive pressure sensors. Further, the sensors are interfaced or communicatively coupled to interrogator electronics, and changes in the sensor outputs are monitored over time and recorded for viewing post-procedure. In another embodiment, a robust connection between the interrogator and the sensors is achieved using a magnetic connector. In another embodiment, Ionic conductors are utilized which are either clear or colorant matched to adjacent tissues to blend into the tissue region. Alternatively, the transparency of metals and graphene can be increased by making very thin layers and some electrical conducting polymers are clear. Highly insulative tissue simulants are utilized surrounding the conductive circuits to prevent crosstalk between circuits and leakage of signals. In some embodiments, wireless communication is utilized as a method to communicate sensor data over time. The relayed data can then be visualized on an external computing device to for instance indicate sensor performance pressure, forces, and cut locations.

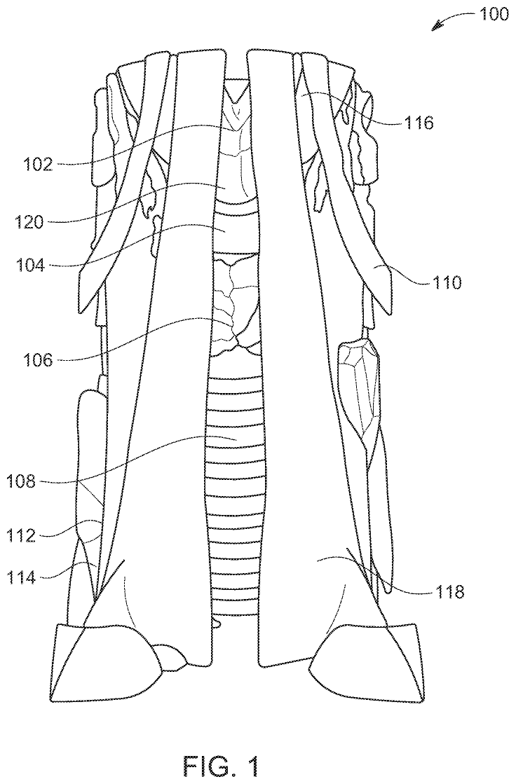

Referring to FIG. 1, an exemplary surgical trainer 100 suitable for providing surgical training for Cricothyrotomy incisions are shown. The surgical trainer 100 (also referred to as Cricothyrotomy surgical trainer) includes one or more synthetic body parts or synthetic organs, for example, a thyroid cartilage 102, a cricoid cartilage 104, a thyroid gland 106, a trachea 108, omohyoids 110, a carotid artery 112, a jugular vein 114, a hyoid bone 116, and sternohyoid muscles 118. In this case, one or more layers of healable synthetic tissues are incorporated in the regions where the incision is performed, for example, in the skin, muscle, adipose, and cricothyroid membrane regions 120. In some embodiments, the cricothyroid membrane region 120 is disposed between the thyroid cartilage 102 and the cricoid cartilage 104. A cricothyrotomy involves making an incision through the skin and cricothyroid membrane 120 to establish an unblocked airway during several life-threatening situations, such as airway obstruction by a foreign body, angioedema, or massive facial trauma. Cricothyrotomy is nearly always performed as a last resort in cases where orotracheal and nasotracheal intubation is impossible or contraindicated. Thus, for surgery training, an incision is made through the cricothyroid membrane and tissues above (i.e., skin, adipose, muscle). As the surgical trainer 100 includes healable synthetic tissues in the cricothyroid membrane 120, the layers of the skin, adipose, and muscle above the cricothyroid membrane 120, the healable synthetic tissues are healed after the incision is made, enabling a repeated utilization of the surgical trainer 100 for training the medical practitioner in Cricothyrotomy incisions. In an embodiment, the healable synthetic tissues include self-healing additives to enable self-healing of the synthetic tissues. In some embodiments, external parameters, such as heat, pressure, pH changes, etc., are applied to enable the healing of the synthetic tissues.

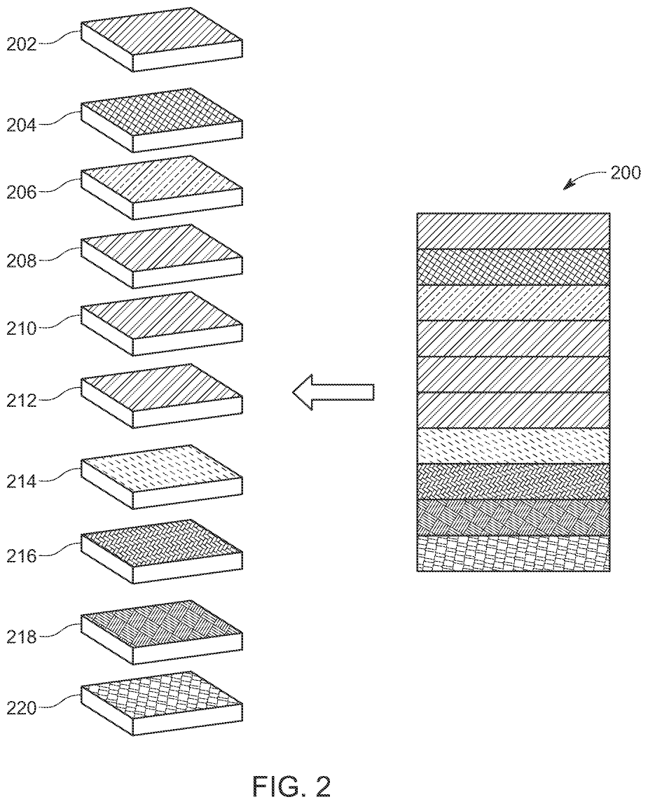

Referring to FIG. 2, an exemplary surgical trainer 200 suitable for providing surgical training for abdominal wall incisions are shown. The surgical trainer 200 (also referred to as abdominal wall trainer) includes a plurality of layers of healable synthetic tissues. The layers may be uniform but vary in the plane of the incision. The abdominal wall trainer 200 includes layers of healable synthetic tissues that vary in color, thickness, and mechanical properties. In the illustrated embodiment, the plurality of layers includes ten layers simulating the abdominal wall. As shown, the plurality of layers includes a skin layer 202, a subcutaneous adipose tissue layer 204, a superficial fascia layer 206, an external oblique muscle layer 208, an internal oblique muscle layer 210, a transversus abdominis muscle layer 212, a transversalis fascia layer 214, a preperitoneal adipose layer 216, and areolar tissue layer 218, and a peritoneum layer 220. In some embodiments, the peritoneum layer 220 consists of a layer of mesothelium (cells) and a thin layer of connective tissue with two folds, the omentum and the mesentery. Each of the layers includes healable synthetic tissues. Moreover, sensors, for example, pressure and cut sensors are embedded in one or more of the layers to evaluate pressure and force applied during surgical training corresponding to trocar insertion. The surgical trainer 200 is also configured to be used for training in various steps of laparoscopic surgery.

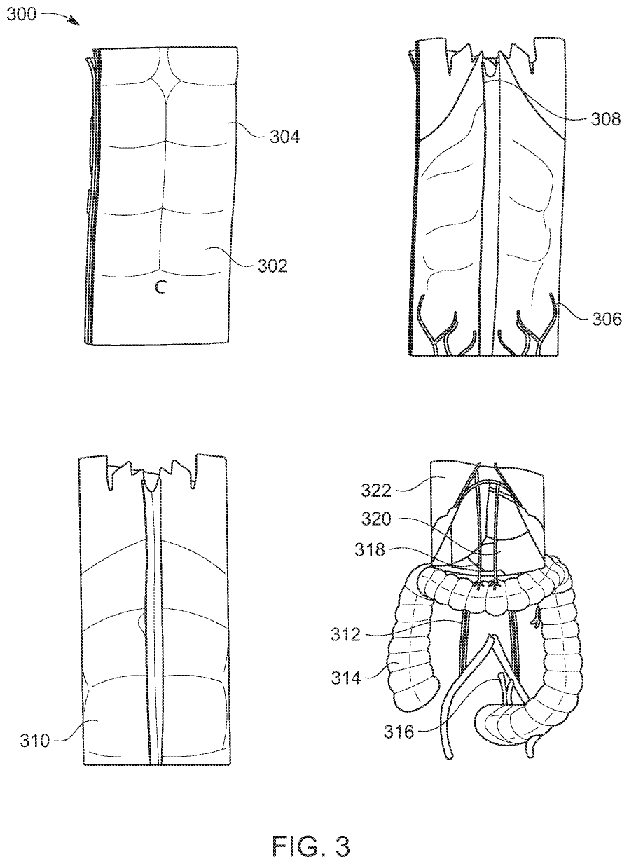

Referring to FIG. 3, an exploded view of an exemplary surgical trainer suitable for providing surgical training related to the abdomen is shown. The surgical trainer includes a plurality of synthetic organs having one or more layers of healable synthetic tissues. As shown, the plurality of synthetic organs includes an umbilicus 302, and a skin 304, epigastric vessels 306, linea Alba 308, rectus abdominis 310, epigastric veins 312, colon 314, iliac artery and vein 316, superior epigastric artery 318, stomach 320, and diaphragm 322.

The surgical trainer 300 is utilized for training correct identification of various landmarks during the surgical procedure. The trainee needs to indicate the optimal trocar location based on landmarks recognized by the user. In the case of laparoscopic surgery, multiple small incisions are made in the abdomen for trocar placement. In some embodiments, the surgical procedure may utilize the Umbilicus as a trocar landmark location. This region exhibits the thinnest distance from the skin to the peritoneal space in the periumbilical area. There are several conditions where this point is not optimal. For instance, the periumbilical area in the pediatric age group should be avoided because the umbilical vessels have not been involuted and can get punctured. Also, the inferior or superior crease of the umbilicus can be used in average-built patients and the trans-umbilical incision can be used in an obese patient. There are many other insertion points, for instance, the intersection of arcuate and semilunar line markings, Douglas' arch or semicircular line, or 9^{th} Cartilage (ribs) can be used as landmark regions. Also, it is common to use the Palmer's point (mid-clavicular line 2-3 finger widths from upper midline 4-5 cm below the left costal margin.

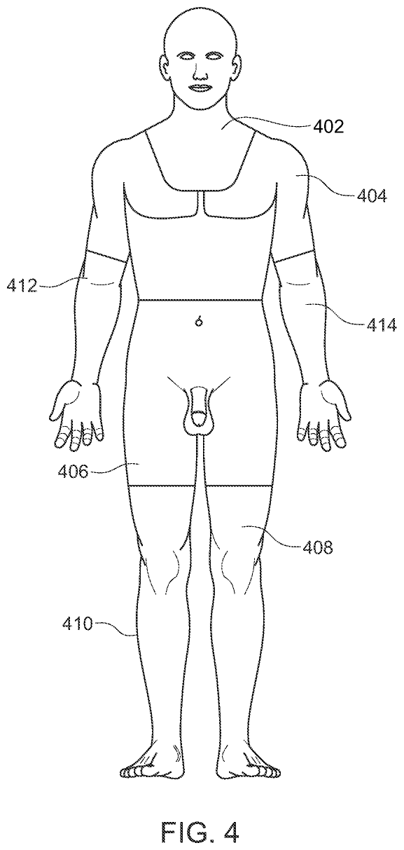

Referring to FIG. 4, a modular manikin 400 is shown as a surgical trainer. The manikin 400 includes a plurality of synthetic body parts 402 including one or more layers of healable synthetic tissues. As shown in FIG. 4, multiple body parts include a head 402, a torso 404, an abdomen 406, a left leg 408, a right leg 410, a left arm 412, and a right-arm 414 and are designed to be assembled. Each body part includes layers of healable synthetic tissues that match physiological tissue parameters, with embedded electronics, fluidics, and sensor components.

In the modular manikin embodiment in addition to the abdominal wall, additional organs and tissues are included for which a full procedure could be simulated. Some examples of common laparoscopic procedures are Laparoscopic Cholecystectomy (Gall bladder), Laparoscopic Colon Resection, Laparoscopic Nissen Fundoplication (stomach, esophagus, diaphragm), Laparoscopic Ventral Hernia Repair, Appendectomy, Laparoscopic radical hysterectomy (TLRH) for gynecological oncology (Cervical cancer), and a series of laparoscopic bariatric surgeries for weight loss (Sleeve gastrectomy or Roux-en-Y gastric bypass). Torso regions can be incorporated into a modular manikin structure to enhance the reusability of components.

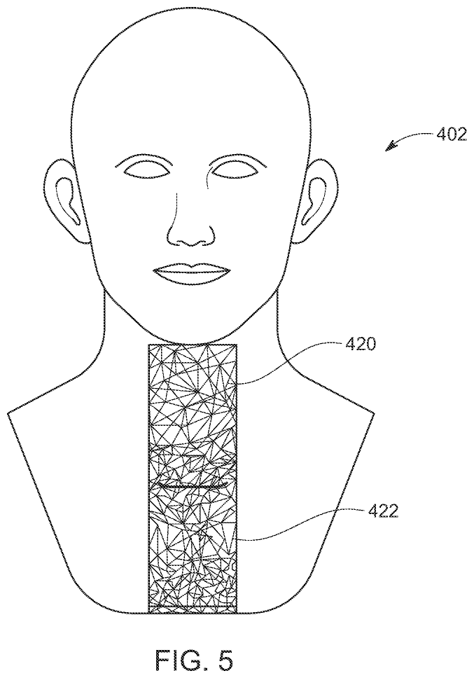

Referring to FIG. 5, the head 402 is shown. The head 402 may be used for training procedures related to a trachea and include a synthetic trachea 404 having healable synthetic tissues. Also, the trachea 404 includes a plurality of sensors and interrogators 406 embedded in the synthetic tissues of the trachea 404.

The disclosure, described is of a healable tissue analog trainer and method for the preparation thereof. The biomimetic tissue analogs teach the procedures indicating different tissues with varying properties that match that of physiological tissues (such as color, mechanical properties, hydration, etc.). A single or multiple healable tissue(s) are suitable for repeated cuts and sutures. The healable materials are positioned in regions in which surgical procedures are performed to be able to repeat the procedure multiple times and reuse the overall training apparatus lowering the overall cost of training. The invention also incorporates embedded sensors such as pressure or force sensors, cut sensors, or other sensors to give feedback and detect fluid flow and surgical tool location. The invention also enables the ability to incorporate fluids. Incorporated vascular regions can bleed synthetic blood when cut or liquids leak from the bowels or other organs when ruptured by poor surgical technique.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, thereby enabling others skilled in the art to best utilize the present disclosure and various embodiments with various modifications as are suited to the particular use contemplated.

What is claimed is:

1. A surgical trainer to facilitate training of a medical practitioner in one or more surgical procedures, the surgical trainer comprising:
one or more layers of healable synthetic tissues, wherein the healable synthetic tissue includes healable material configured to facilitate a re-bonding of the healable synthetic tissues to their original shape after an incision is made to the healable synthetic tissues.

2. The surgical trainer of claim 1, wherein the healable synthetic tissues are self-healable synthetic tissues comprising at least one selected from hydrogen bonding, ionic bonding, van der Waal forces, covalent bonding, dynamic hydrogen bonding, hydrophobic interactions, dynamic covalent bonds or Schiff base, disulfide bonds, and Diels-Alder reactions, or a combination of intermolecular interactions.

3. The surgical trainer of claim 1, wherein the healable synthetic tissues comprise at least a supermolecular, a reversible covalent bond, or a combination thereof.

4. The surgical trainer of claim 1, wherein the healing of the healable synthetic tissue is activated by exposing said healable synthetic tissue to at least one factor selected from heat, pH changes, pressure, energy, hydration, dehydration, water diffusion, surface modification treatment, or a combination thereof.

5. The surgical trainer of claim 1 further comprises one or more layers of non-healable synthetic tissues.

6. The surgical trainer of claim 1, wherein the healable synthetic tissues comprise one or more self-healing additives to initiate the re-bonding of synthetic tissue material.

7. The surgical trainer of claim 6, wherein the self-healing additives initiate rebonding of synthetic tissue material via at least one selected from dynamic hydrogen bonding, ionic bonding, van der Waal forces, hydrophobic interactions, dynamic covalent bonds or bidirectional reactions such as Schiff base, disulfide bonds, and Diels-Alder reactions, or a combination of intermolecular interactions.

8. The surgical trainer of claim 1 further comprises a plurality of sensors positioned within at least one layer of the healable synthetic tissues configured to detect both the magnitude and relative position of an external force and incision applied to the healable synthetic tissue.

9. The surgical trainer of claim 8, wherein the sensors are at least one selected from a pressure sensor, a force sensor, a cut sensor, or a combination thereof.

10. The surgical trainer of claim 1, wherein, the healable synthetic tissue further comprises at least one selected from a colorant, a gelling agent, a plasticizer, a humectant, a preservative, or a combination thereof.

11. The surgical trainer of claim 1, wherein the healable synthetic tissue has a tensile strength in the range of 1 kPa to 100 MPa.

12. A modular manikin for surgical training simulation, the modular manikin comprising:
at least one synthetic body part comprising one or more layers of healable synthetic tissues, wherein
the healable synthetic tissues include healable material configured to facilitate a re-bonding of the healable synthetic tissues to their original shape after an incision is made to the healable synthetic tissues.

13. The modular manikin of claim 12, wherein the healable synthetic tissues are self-healable synthetic tissues comprising at least one selected from hydrogen bonding, ionic bonding, van der Waal forces, covalent bonding, dynamic hydrogen bonding, hydrophobic interactions, dynamic covalent bonds or Schiff base, disulfide bonds, and Diels-Alder reactions, or a combination of intermolecular interactions.

14. The modular manikin of claim 12, wherein the healable synthetic tissues comprise at least a supermolecular, a reversible covalent bond, or a combination thereof.

15. The modular manikin of claim 12, wherein the healing of the healable synthetic tissue is activated by exposing said healable synthetic tissue to at least one factor selected from heat, pH changes, pressure, energy, hydration, dehydration, surface modification treatment, water diffusion, or a combination thereof.

16. The modular manikin of claim 12, wherein the at least one synthetic body part comprises one or more layers of non-healable synthetic tissues.

17. The modular manikin of claim 12, wherein the healable synthetic tissues comprise one or more self-healing additives to initiate the re-bonding of synthetic tissue material.

18. The modular manikin of claim 12 further comprises a plurality of sensors positioned within at least one layer of the healable synthetic tissues configured to detect both the magnitude and relative position of an external force and incision applied to the healable synthetic tissue.

19. The modular manikin of claim 18, wherein the sensors are at least one selected from a pressure sensor, a force sensor, a cut sensor, or a combination thereof.

20. The modular manikin of claim 12, wherein the healable synthetic tissue further comprises at least one selected from a colorant, a gelling agent, a plasticizer, a humectant, a preservative, or a combination thereof.
